(19) United States
(12) Patent Application Publication
(10) Pub. No.: US 2019/0010732 A1
(43) Pub. Date: Jan. 10, 2019

(54) TWO-DIMENSIONALLY DRIVEN LOCK, KEY, AND UNLOCKING METHOD THEREOF

(71) Applicant: Min-Te Shen, New Taipei City (TW)

(72) Inventor: Min-Te Shen, New Taipei City (TW)

(21) Appl. No.: 16/026,441

(22) Filed: Jul. 3, 2018

(30) Foreign Application Priority Data
Jul. 10, 2017 (TW) 106122974

(51) Int. Cl. E05B 49/00; E05B 19/00; E05B 27/00

(52) U.S. Cl. CPC E05B 49/008; E05B 27/0021; E05B 19/0052

(57) ABSTRACT

A two-dimensionally driven lock and key are provided. The two-dimensionally driven lock has a lock core having sliders and a block. The sliders are movably and rotatably mounted in the lock core. Each slider has a recessed portion and a non-circular positioning portion. The block has protrusion portions selectively received in the recessed portions. The key has positioning dimples identical to the positioning portion in shape. When the key is inserted into the lock core, the positioning portions match to the positioning dimples respectively and the protrusion portions face to the recessed portions. An unlocking method includes inserting a key into a lock core to make the recessed portion and the protrusion portion face and align to each other by moving and rotating the sliders. Therefore, a location of the recessed portion can vary on the slider in two dimensions, and thus making ulocking very difficult.

### CROSS-REFERENCE TO RELATED APPLICATIONS

This application is based upon and claims priority under 35 U.S.C. 119 from Taiwan Patent Application No. 106122974 filed on Jul. 10, 2017, which is hereby specifically incorporated herein by this reference thereto.

### BACKGROUND OF THE INVENTION

### 1. Field of the Invention

The present invention relates to a lock mechanism and a key, and relates to an unlocking method.

### 2. Description of the Prior Arts

A conventional lock mechanism comprises a casing, a lock core, and multiple sliders. The casing comprises multiple abutting blocks and multiple springs, and forms an accommodating space. The abutting blocks are arranged in a straight line and are capable of moving in another line. One end of each abutting block is selectively located in the accommodating space and another end of each abutting block is connected to one of the springs, and thereby the abutting blocks are pushed toward the accommodating space. The lock core is rotatably mounted in the accommodating space and forms multiple holes and a key way to be inserted by a key. The holes respectively extend in a moving direction of the abutting blocks, and thus when the ends of the abutting blocks are in the accommodating space, said ends further pass through the holes of the lock core, which makes the lock core non-rotatable. The holes communicate with the key way, and the sliders are respectively movably mounted in the holes. One end of each slider is selectively located in the key way, and another end of each slider is selectively abutted by one of the blocks.

When the key is not inserted in the lock core yet, the sliders are pushed by the abutting blocks and the ends of the sliders are in the key way, and the two ends of each abutting block are in the lock core and in the casing respectively so that the lock core cannot be rotated; when the key is inserted in the key way, the sliders and the abutting blocks are pushed by the key toward the springs, and interfaces of the sliders and the abutting blocks are aligned to interfaces of the casing and the lock core so that the lock core is rotatable.

However, in the aforesaid structure that the abutting blocks are arranged in a line, the lock is easy to be unlocked by someone intentionally even without the right key. Precisely, tolerances during manufacture of the lock are inevitable, so some gaps between the abutting blocks and inner surfaces of the holes are narrower than those of others. If the lock core is rotated when the sliders and the abutting blocks are located in their respective correct positions, the abutting blocks may abut the inner surfaces of the holes and thereby the lock core cannot be rotated, and force is concentrated at the abutting block that forms the smallest gap with respect to the inner surface of the corresponding hole. After said abutting block is pushed to move out of the corresponding hole, the lock core can be rotated slightly. Then, because the remaining abutting blocks are not moved out of the corresponding holes yet, one of the remaining abutting blocks that form the second smallest gap with respect to the inner surface of the corresponding hole abuts the inner surface of the corresponding hole and thus prevents the lock core from rotation. Besides, because the sliders and the abutting blocks in the conventional lock mechanism are only capable of moving in one dimension, in the process of pushing the sliders and the abutting blocks, the interface of the sliders and the abutting blocks is inevitably aligned to the interface of the casing and the lock core. Therefore, the lock mechanism may be unlocked after the aforesaid process is repeated several times.

This unlocking process is well known not only for locksmiths, but also for many people not in the locksmith profession. In other words, such conventional lock mechanism does not provide solid protection since the unlocking method is too accessible.

To overcome the shortcomings, the present invention provides a two-dimensionally driven lock, a key, and an unlocking method thereof to mitigate or obviate the aforementioned problems.

### SUMMARY OF THE INVENTION

The main objective of the present invention is to provide a two-dimensionally driven lock that has a movable and rotatable slider so that a recessed portion of the slider is disposed two-dimensionally.

The two-dimensionally driven lock has an outer casing and a lock core. The outer casing forms an accommodating space and a cavity communicating with the accommodating space. The lock core is rotatably mounted through the outer casing and comprises an inner casing, at least one slider, at least one first elastic component, at least one block, and at least one second elastic component. The inner casing is rotatably mounted through the accommodating space of the outer casing and comprises a key way and at least one hole. One end of each one of the at least one hole communicating with the key way. The at least one slider is movably mounted through the at least one hole and is capable of rotating with respect to the corresponding hole about a rotating axis parallel with an extending direction of the corresponding hole. Each one of the at least one slider comprising a slider main body and a positioning portion. The slider main body has a recessed portion. The positioning portion is securely mounted on one end of the slider main body and located in the key way. A sectional shape of the positioning portion is non-circular. The at least one first elastic component is mounted in the inner casing and connected to the at least one slider respectively, and thereby the slider tends to move toward the key way. The at least one block is movably mounted through the inner casing. Each one of the at least one block comprises a block main body and at least one protrusion portion. A portion of the block main body is selectively received in the cavity of the outer casing. The at least one protrusion portion selectively received in the recessed portion of one of the at least one slider. The at least one second elastic component is mounted in the inner casing and connected with the at least one block, and thereby the at least one block tendes to move toward the cavity of the outer casing.

To achieve the aforementioned objective, a key matching to the aforesaid two-dimensionally driven lock is provided and has at least one positioning dimple. The at least one positioning dimple corresponds to the positioning portion of the at least one slider of said two-dimensionally driven lock in location. A sectional shape and a sectional area of each one of the at least one positioning dimple are identical to those of the positioning portion of the at least one slider. When the key is inserted in the key way, the positioning portion of each one of the at least one slider is received in the corresponding positioning dimple, and the at least one protrusion portion of the at least one block of said two-dimensionally driven lock faces to the at least one recessed portion of the at least one slider.

To achieve the aforementioned objective, an unlocking method is provided. The unlocking method starting with a recessed portion of at least one slider of a lock core of a lock dislocated with respect to at least one protrusion portion of at least one block of the lock core, thereby preventing the at least one protrusion portion from moving into the recessed portion; and the at least one block engaged in a cavity of an outer casing of the lock, thereby making the lock core non-rotatable with respect to the outer casing. The unlocking method includes the following steps: insert a key in the lock core and align at least one positioning dimple of the key to a positioning portion of the at least one slider, thereby the key drives the at least one slider to move and rotate through the at least one positioning dimple matching to the positioning portion of the at least one slider, and the recessed portion of the at least one slider faces to the at least one protrusion portion of the at least one block, thereby making the at least one protrusion portion capable of moving into the recessed portion of the at least one slider and the at least one block capable of moving out of the cavity of the outer casing. And then, rotate the key to drive the lock core to rotate with respect to the outer casing with the at least one block moving out of the cavity of the outer casing and the at least one protrusion portion moving into the recessed portion of the at least one slider.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a two-dimensionally driven lock in accordance with the present invention;

FIG. 2 is an exploded perspective view of the two-dimensionally driven lock in FIG. 1;

FIG. 3 is a sectional view of the two-dimensionally driven lock in FIG. 1;

FIG. 4 is a perspective view of a slider of the two-dimensionally driven lock in FIG. 1;

FIG. 5 is a bottom view of a lock core of the two-dimensionally driven lock in FIG. 1;

FIG. 6 is a perspective view of the lock core in FIG. 5;

FIG. 7 is a perspective view of a key in accordance with the present invention;

FIG. 8 is a sectional view of the two-dimensionally driven lock across line A-A in FIG. 3 before the key is inserted;

FIG. 9 is a sectional view of the two-dimensionally driven lock across line A-A in FIG. 3 after the key is inserted;

FIG. 10 is a sectional view of the two-dimensionally driven lock across line B-B in FIG. 3 before the key is inserted; and

FIG. 11 is a sectional view of the two-dimensionally driven lock across line B-B in FIG. 3 after the key is inserted.

### DETAILED DESCRIPTION OF THE PREFERRED EMBODIMENTS

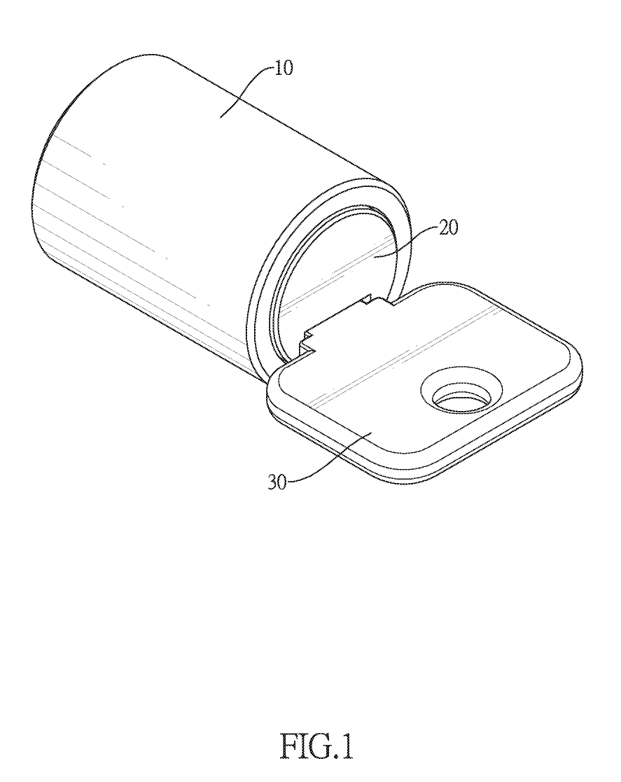

With reference to FIGS. 1 to 3, a two-dimensionally driven lock in accordance with the present invention comprises an outer casing 10 and a lock core 20. A key 30 in accordance with the present invention for the two-dimensionally driven lock is also provided. The outer casing 10 forms an accommodating space 11 and a cavity 12 communicating with each other. The lock core 20 is rotatably mounted through the outer casing 10 and comprises an inner casing 21, at least one slider 22, at least one first elastic component 23, at least one block 24, and at least one second elastic component 25. In this embodiment, a number of the at least one slider 22 is three, and a number of the at least one first elastic component 23 equals that of the sliders 22; a number of the at least one block 24 is one and a number of the at least one second elastic component 25 is two. However, the numbers of the components above are not limited thereto.

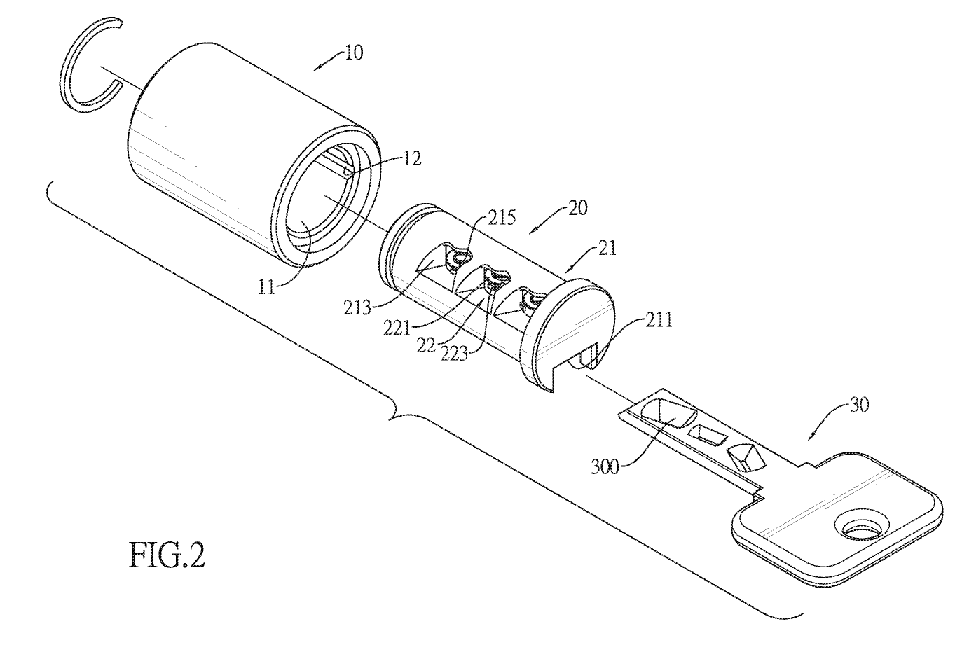

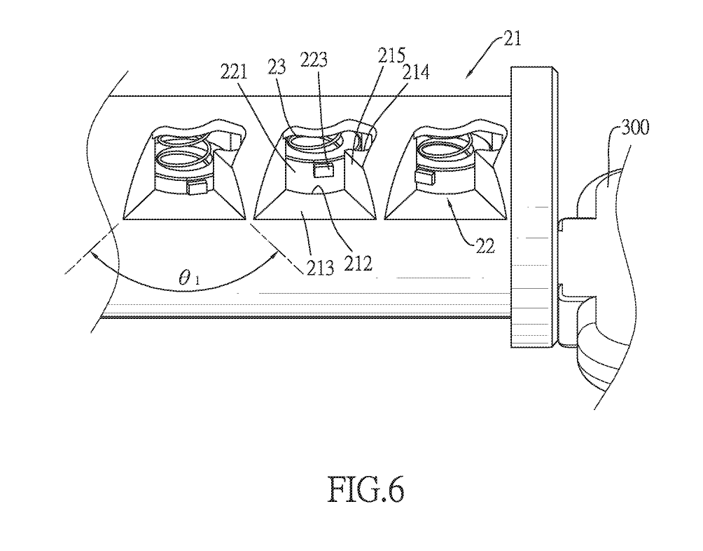

Then please refer to FIG. 2 and FIG. 6. The inner casing 21 is rotatably mounted through the accommodating space 11 of the outer casing 10 and forms a key way 211, at least one hole 212, at least one opening 213, and at least one assembling groove 214. The key way 211 is selectively inserted by the key 30. In this embodiment, numbers of the at least one hole 212, the at least one opening 213, and the at least one assembling groove 214 equal that of the sliders 22. One end of each hole 212 communicates with the key way 211 and another end of each hole 212 communicates with one of the openings 213. One end of each assembling groove 214 communicates with the key way 211 and another end of each assembling groove 214 communicates with an end of one of the openings 213, and each assembling groove 214 laterally communicates with one of the holes 212. In other words, viewed from each one of the openings 213, the whole opening 213 communicates with the corresponding hole 212, but only the end of the opening 213 communicates with the corresponding assembling groove 214. Therefore, a tab 215 is formed between each one of the openings 213 and the corresponding assembling groove 214 so only an end portion of the opening 213 communicates with the assembling groove 214. In this embodiment, an angle between two lateral walls of the opening 213 is a first angle θ1 and the first angle θ1 ranges from 40 degrees to 60 degrees, e.g. 50 degrees. Imaginary extending surfaces of the two lateral walls of each one of the openings 213 intersect at a center axis of the corresponding hole 212.

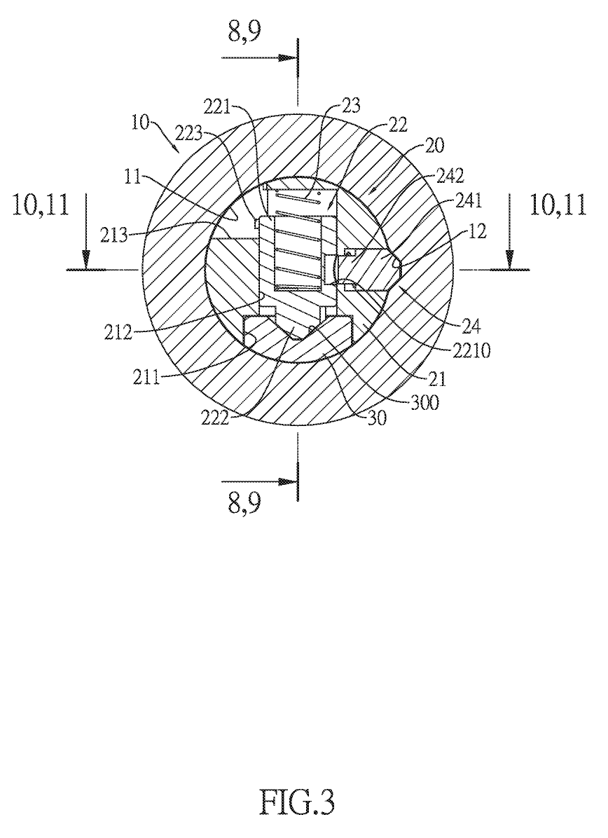

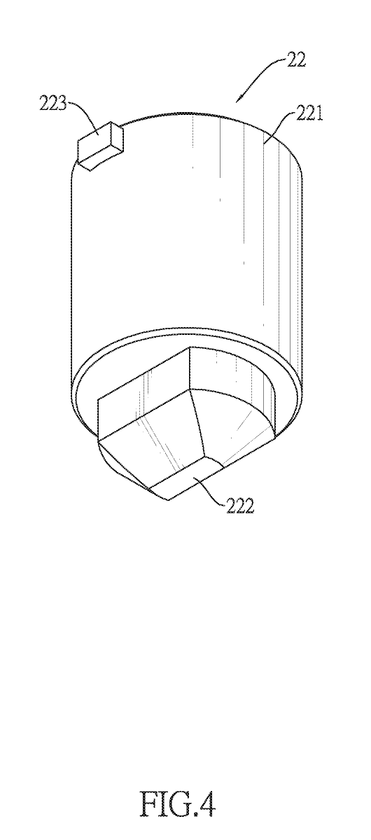

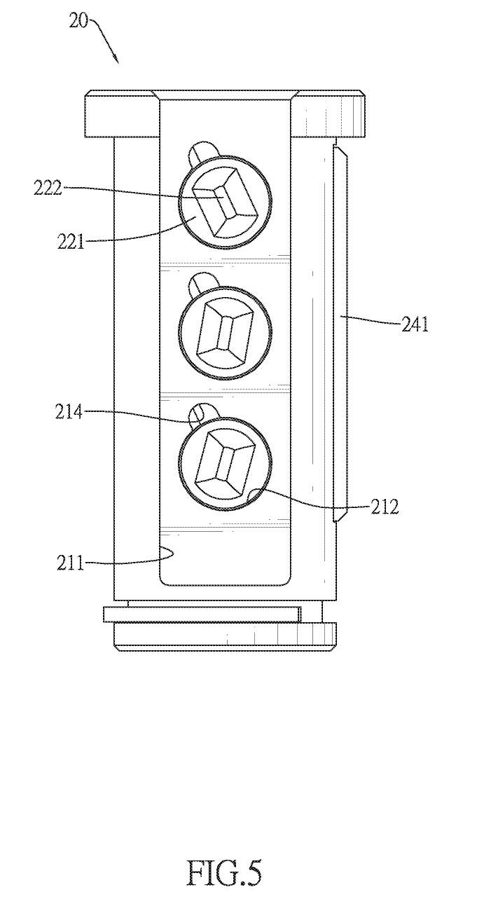

Then please refer to FIGS. 3, 4, and 5. Each one of the sliders 22 is movably mounted through one of the holes 212 of the inner casing 21 and capable of rotating about a rotating axis parallel with an extending direction of the corresponding hole 212. Each one of the sliders 22 comprises a slider main body 221, a positioning portion 222, and a restriction portion 223. The slider main body 221 is movably and rotatably mounted through the hole 212 and forms a recessed portion 2210. The recessed portion 2210 is formed on an outer surface of the slider main body 221. A sectional shape of the recessed portion 2210 may be circular or polygonal, but it is not limited thereto. The positioning portion 222 is securely mounted on an end of the slider main body 221 and located in the key way 211. The positioning portion 222 symmetrically tapers from the slider main body 221, and a sectional shape of the positioning portion 222 is non-circular, e.g. polygonal or elliptical. In this embodiment, the sectional shape of the positioning portion 222 is rectangular. The restriction portion 223 protrudes out of a lateral surface of the slider main body 221 and is located in the corresponding opening 213. Thus, when the slider 22 is rotated, the restriction portion 223 can only move within the opening 213 and thereby the rotating angle of the slider 22 is restricted. In other words, the restriction portion 223 can only move between the two lateral walls of the opening 213.

The first elastic components 23 are mounted in the inner casing 21 and connected with the sliders 22 respectively, and thereby the slider 22 tends to move toward the key way 211. In other words, the positioning portion 222 of the slider main body 221 remains in the key way 211.

The please refer to FIG. 3 and FIG. 6. In the process of assembling the sliders 22 into the lock core 20, the slider main bodies 221 are aligned to the holes 212 of the lock core 20 and the restriction portions 223 are aligned to the assembling groove 214 of the lock core 20, so that the sliders 22 are capable of being moved into the lock core 20. Then, when the slider main bodies 221 arrive at the deepest portion of the holes 212, the restriction portions 223 also arrive at the deepest portion of the assembling groove 214. Because the deepest portion of the assembling groove 214 communicates with the end portion of the opening 213 of the lock core 20, the restriction portion 223 can be moved into the openings 213 after the sliders 22 are rotated. With the first elastic components 23 keeping pushing the slider main bodies 221, after the operator releases the sliders 22, the sliders 22 will move toward the key way 211, and the restriction portions 223 are restricted within the opening 213 and the tabs 215 prevent the restriction portions 223 from being moved into the assembling grooves 214.

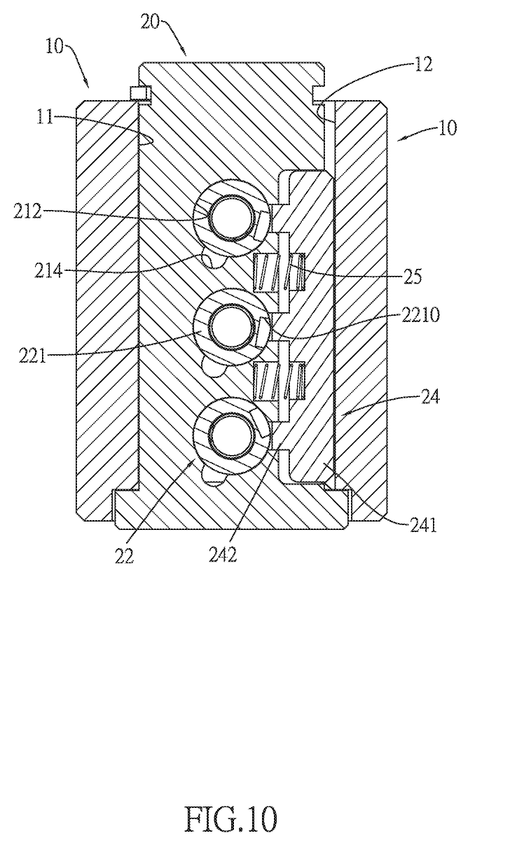

Then please refer to FIG. 3 and FIG. 10. The block 24 is movably mounted through the inner casing 21 and comprises a block main body 241 and a plurality of protrusion portions 242. A number of the protrusion portions 242 equals that of the sliders 22, so in this embodiment, a number of the protrusion portions 242 is three. A portion of the block main body 241 is selectively received in the cavity 12 of the outer casing 10. For example, in this embodiment, a side of the block main body 241 is received in the cavity 12 so that the block main body 241 is engaged with the outer casing 10, and two surfaces of the block main body 241 aside said side are two inclined surfaces. Each protrusion portion 242 is securely mounted on another side of the block main body 241 that is opposite the cavity 12. A sectional shape of each protrusion portion 242 may be circular or polygonal, and the sectional shape of each protrusion portion 242 is identical to that of a respective one of the recessed portions 2210, so that each protrusion portion 242 can be selectively received in one of the recessed portions 2210 of the slider 22. However, the sectional shape of the protrusion portion 242 may not be identical to that of the corresponding recessed portion 2210, as long as the protrusion portion 242 is capable of being moved into the recessed portion 2210. The second elastic components 25 are mounted in the inner casing 21 and connected with the block 24, and thereby the block 24 tends to move toward the cavity 12 of the outer casing 10. In another embodiment, the numbers of the block 24 and the second elastic component 25 both equal that of the sliders 22.

In addition, with the sliders 22 capable of moving parallel to their rotating axis and rotating about their rotating axis, after the sliders 22 are moved and/or rotated, the recessed portions 2210 of the slider 22 can face to or be dislocated from the protrusion portions 242. Therefore, a location of each recessed portion 2210 on the corresponding slider main body 221 is at any site that can face to the protrusion portion 242 during moving and rotation of the slider 22. In other words, a preferred site for arranging the recessed portion 2210 is various in a two-dimension scope.

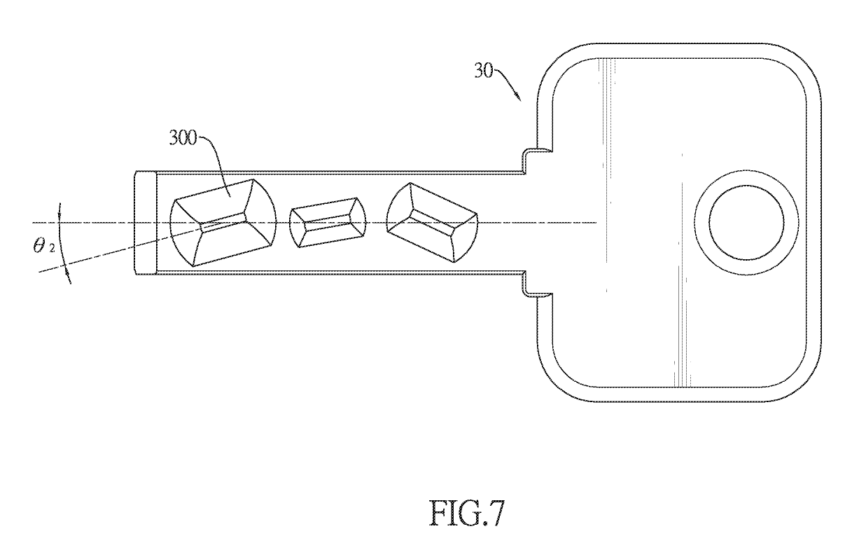

Then please refer to FIGS. 3, 4, and 7. The key 30 is selectively mounted through the key way 211 and comprises at least one positioning dimple 300. In this embodiment, the positioning dimple 300 is on a surface of the key 30 and said surface is parallel to a width direction of the key 30. A number of the positioning dimple 300 equals that of the sliders 22, so in this embodiment, the key 30 has three positioning dimples 300, but it is not limited thereto. Each positioning dimple 300 corresponds to the positioning portion 222 of the slider 22 in location, and a sectional shape and a sectional area of each positioning dimple 300 are identical to those of the corresponding positioning portion 222. Thus, each one of the positioning dimples 300 is concaved conically, and the sectional shape is rectangular. An angle between a lengthwise direction of the rectangular positioning dimple 300 and an extending direction of the key 30 is less than or equal to 45 degrees.

In another embodiment, the positioning dimple 300 may be formed on a surface of the key 30, said surface being parallel to a thickness direction of the key 30, and each positioning dimple 300 only has a front wall and a rear wall and the front wall and the rear wall are inclined corresponding to the positioning portions 222 of the sliders 22.

In this embodiment, centers of the positioning dimples 300 are arranged in a line parallel to the extending direction of the key 30. However, in another embodiment, the centers of the positioning dimples 300 may not be arranged in a line.

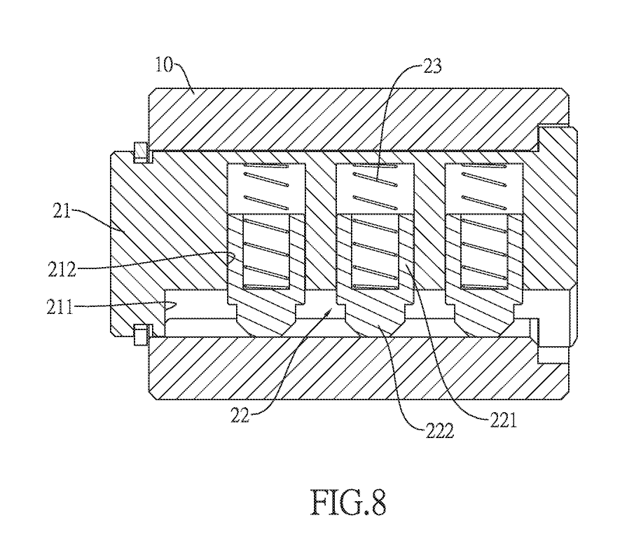

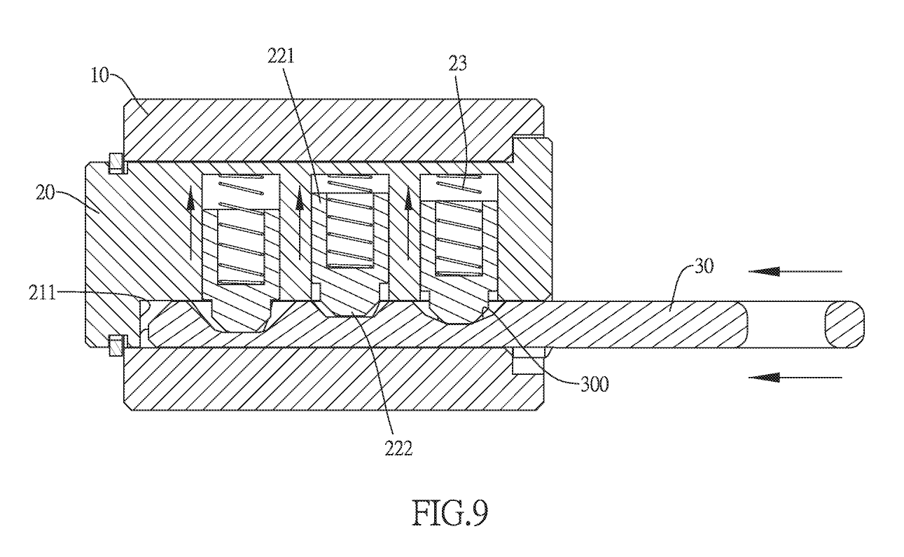

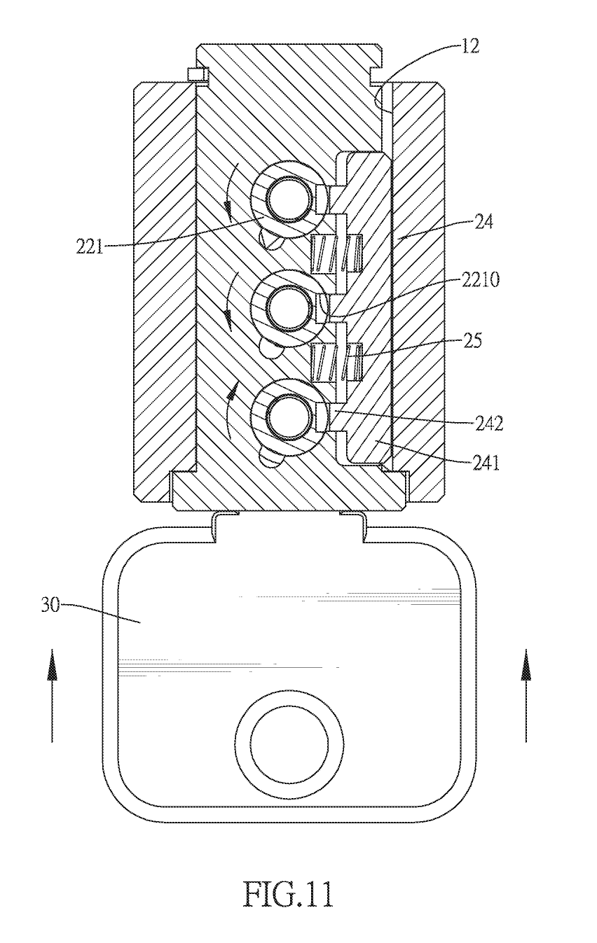

Then refer to FIGS. 8 to 11. According to the aforementioned structure, an unlocking method is also provided. The unlocking method mainly includes the following steps: a beginning state, inserting the key, and turning the key. In the beginning state, the recessed portions 2210 of the sliders 22 are dislocated with respect to the protrusion portions 242 of the block 24, and thereby the protrusion portions 242 cannot be moved into the recessed portions 2210 so that the block 24 keeps engaging the cavity 12 of the outer casing 10. Therefore, the lock core 20 cannot be rotated with respect to the outer casing 10. In other words, the two-dimensionally driven lock is in a locked state.

Then, insert the key. After the key 30 is inserted, the positioning dimples 300 respectively correspond to the positioning portions 222 of the slider 22, and thus the key 30 drives the sliders 22 to move and rotate through the positioning dimples 300 matching the positioning portions 222, and thereby the recessed portions 2210 of the sliders 22 face to the protrusion portion 242 of the block 24. Meanwhile, the protrusion portions 242 are capable of moving into the recessed portions 2210 of the sliders 22 and the block 24 is capable of moving out of the cavity 12 of the outer casing 10. However, the protrusion portions 242 do not automatically move into the recessed portion 2210 so that the block 24 also does not automatically move out of the cavity 12.

Precisely, with the key 30 inserted into the key way 211, the positioning portions 222 of the sliders 22 can rotate according to the positioning dimples 300 of the key 30 and move according to depths of the positioning dimples 300, so that the recessed portions 2210 of the sliders 22 can face to the protrusion portions 242 of the block 24. If all of the recessed portions 2210 respectively face to the protrusion portions 242 and thereby the protrusion portions 242 can be moved into the recessed portions 2210, the block 24 can be moved toward the slider 22 and out of the cavity 12 of the outer casing 10.

Then, turn the key. When the key 30 is turned, because the two inclined surfaces of the block 24 aside the side of the block 24 received in the cavity 12 serve as guiding surfaces, the two inclined surfaces of the block 24 may push the block 24 to move out of the cavity 12 and thus the protrusion portions 242 move into the recessed portions 2210.

On the other hand, when the key 30 is turned back to the original position and pulled out of the key way 211, the sliders 22 may be pushed back by the first elastic components 23 toward the key way 211. Precisely, a shock is generated while the key 30 is being pulled out and the sliders 22 are being pushed back toward the key way 211, and the shock may make the slider 22 rotate randomly, so that the two-dimensionally driven lock returns back to the locked state.

The unlocking method is not limited to be applied on the two-dimensionally driven lock and the key 30, as long as a lock has an outer casing and a lock core, and the outer casing comprises a cavity, the lock core comprises at least one movable and rotatable slider and a block that is capable of engaging the cavity of the outer casing and moving in or out of a recessed portion of the slider.

With aforesaid structures, different keys 30 may have the positioning dimples 300 in amounts other than those aforementioned, and the positioning dimples 300 are different from each other in angle and depth. Thus, the key 30 may have more different codes for unlocking. Corresponding to the positioning dimples 300 of the key 30, the lock core 20 may have the sliders 22 also in another amount, and the recessed portions 2210 may be disposed at different sites on both an axial scope and a circumferential scope of the slider main body 221, so that the locations of the recessed portions 2210 vary in two dimensions.

Precisely, if a stroke of the slider 22 in the hole 212 is two millimeters and the protrusion portions 242 cannot be moved into the recessed portions 2210 if the recessed portions 2210 are dislocated more than zero point two millimeters, the locations of the recessed portions 2210 may have ten variations in moving directions of the sliders 22. Similarly, if a rotating scope of the slider 22 is 50 degrees and the protrusion portions 242 cannot be moved into the recessed portions 2210 if the recessed portion 2210 is dislocated more than 5 degrees, the locations of the recessed portions 2210 may have ten variations in rotating directions of the sliders 22. Therefore, the location of the recessed portions 2210 can vary in the moving direction and the rotating direction of the sliders 22, so one slider 22 may generate one hundred variations of locations of the recessed portion 2210, and three sliders 22 may generate one million location variations, four sliders 22 may generate one hundred million location variations, etc. The length of the stroke, the angle of the rotating scope, and intervals are exemplary and are not limited thereto.

On the other hand, someone who does not have the right key 30 cannot use the conventional method to make the slider 22 having the smallest tolerance abut the outer casing 10 and thus push the sliders 22 to an unlocked position one by one. Precisely, if the right key 30 is not inserted in the key way 211 yet, even if the lock core 20 is turned, the outer casing 10 and the lock core 20 may push each other, and the push force is exerted on the inclined surface of the block 24, thereby making the block 24 move toward the sliders 22, and thus one of the protrusion portions 242 of the block 24 abuts the outer surface of the corresponding slider main body 221 with the smallest tolerance. To make the recessed portion 2210 of said slider 22 face the protrusion portion 242, the protrusion portion 242 has to be adjusted to a correct position in two dimensions. Therefore, without special equipment for adjusting the position and the angle of the sliders 22 mechanically and systematically, manual operation is not capable of checking all the positions and angles, thereby making unlocking very difficult.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A two-dimensionally driven lock comprising:
an outer casing forming:
an accommodating space; and
a cavity communicating with the accommodating space;
a lock core rotatably mounted through the outer casing and comprising:
an inner casing rotatably mounted through the accommodating space of the outer casing and comprising:
a key way; and
at least one hole; one end of each one of the at least one hole communicating with the key way;
at least one slider movably mounted through the at least one hole and capable of rotating with respect to the corresponding hole about a rotating axis parallel with an extending direction of the corresponding hole;
each one of the at least one slider comprising:
a slider main body having:
a recessed portion; and
a positioning portion securely mounted on one end of the slider main body and located in the key way; a sectional shape of the positioning portion being non-circular;
at least one first elastic component mounted in the inner casing and connected to the at least one slider respectively and thereby the slider tending to move toward the key way;
at least one block movably mounted through the inner casing;
each one of the at least one block comprising:
a block main body, a portion of the block main body selectively received in the cavity of the outer casing; and
at least one protrusion portion selectively received in the recessed portion of one of the at least one slider; and
at least one second elastic component mounted in the inner casing and connected with the at least one block, and thereby the at least one block tending to move toward the cavity of the outer casing.

2. The two-dimensionally driven lock as claimed in claim 1, wherein: the inner casing forms:
at least one opening; each one of the at least one opening communicating with another end of one of the at least one hole; said another end being opposite to the key way; and
each one of the at least one slider further comprises:
a restriction portion; the restriction portion protruding out of a lateral surface of the corresponding slider main body and located in one of the at least one opening, and thereby a rotating angle of the slider is restricted in the opening.

3. The two-dimensionally driven lock as claimed in claim 2, wherein the inner casing further forms:
at least one assembling groove; one end of each one of the at least one assembling groove communicating with the key way, each one of the at least one assembling groove laterally communicating with one of the at least one hole, and another end of each one of the at least one assembling groove communicating with an end of one of the at least one opening.

4. The two-dimensionally driven lock as claimed in claim 2, wherein an angle between two lateral walls of the opening ranges from 40 degrees to 60 degrees; the restriction portion of each one of the at least one slider is located between the two lateral walls of the opening, and thereby the rotating angle of the slider is restricted within the two lateral walls of the opening.

5. The two-dimensionally driven lock as claimed in claim 1, wherein the positioning portion of each one of the at least one slider symmetrically tapers from the slider main body.

6. The two-dimensionally driven lock as claimed in claim 3, wherein the positioning portion of each one of the at least one slider symmetrically tapers from the slider main body.

7. The two-dimensionally driven lock as claimed in claim 4, wherein the positioning portion of each one of the at least one slider symmetrically tapers from the slider main body.

8. The two-dimensionally driven lock as claimed in claim 1 having only one said block, and the block having multiple said protrusion portions; wherein the lock core comprises multiple said sliders, a number of the sliders being equal to that of the protrusion portions.

9. The two-dimensionally driven lock as claimed in claim 6 having only one said block, and the block having multiple said protrusion portions; wherein the lock core comprises multiple said sliders, a number of the sliders being equal to that of the protrusion portions.

10. The two-dimensionally driven lock as claimed in claim 7 having only one said block, and the block having multiple said protrusion portions; wherein the lock core comprises multiple said sliders, a number of the sliders being equal to that of the protrusion portions.

11. A key matching to the two-dimensionally driven lock as claimed in claim 1 and selectively mounted through the key way of said two-dimensionally driven lock; the key comprising:
at least one positioning dimple corresponding to the positioning portion of the at least one slider of said two-dimensionally driven lock in location; and a sectional shape and a sectional area of each one of the at least one positioning dimple being identical to those of the positioning portion of the at least one slider;
wherein when the key is inserted in the key way, the positioning portion of each one of the at least one slider is received in the corresponding positioning dimple, and the at least one protrusion portion of the at least one block of said two-dimensionally driven lock faces to the at least one recessed portion of the at least one slider.

12. The key as claimed in claim 11, wherein the sectional shape of each one of the at least one positioning dimple is a rectangle, and an angle between a lengthwise direction of the rectangle and an extending direction of the key is less than or equal to 45 degrees.

13. An unlocking method starting with a recessed portion of at least one slider of a lock core of a lock dislocated with respect to at least one protrusion portion of at least one block of the lock core, thereby preventing the at least one protrusion portion from moving into the recessed portion; and the at least one block engaged in a cavity of an outer casing of the lock, thereby making the lock core non-rotatable with respect to the outer casing; the unlocking method including the following steps:
inserting a key in the lock core, and aligning at least one positioning dimple of the key to a positioning portion of the at least one slider, thereby the key driving the at least one slider to move and rotate through the at least one positioning dimple matching to the positioning portion of the at least one slider, and the recessed portion of the at least one slider facing to the at least one protrusion portion of the at least one block, thereby making the at least one protrusion portion capable of moving into the recessed portion of the at least one slider and the at least one block capable of moving out of the cavity of the outer casing; and
rotating the key to drive the lock core to rotate with respect to the outer casing with the at least one block moving out of the cavity of the outer casing and the at least one protrusion portion moving into the recessed portion of the at least one slider.
